(19) United States
(12) Patent Application Publication
(10) Pub. No.: US 2007/0219843 A1
(43) Pub. Date: Sep. 20, 2007

(54) Method and apparatus for providing work flows used to resolve alarm conditions detected in a system

(76) Inventors: Jesse M. Keeler, Tempe, AZ (US); Edward S. Halpern, Naperville, IL (US); Frank D. Miller, Lake Zurich, IL (US); David J. Ness Cohn, Morton Grove, IL (US)

Correspondence Address: MOTOROLA, INC., 1303 EAST ALGONQUIN ROAD, IL01/3RD, SCHAUMBURG, IL, 60196, US

(21) Appl. No.: 11/374,862

(22) Filed: Mar. 14, 2006

(51) Int. Cl. G06F 15/02

(52) U.S. Cl. 705/9

(57) ABSTRACT

A method and apparatus of providing workflows (400-404) to the operators of network management systems (114) and subsystems (202-208) is disclosed. The method identifies a plurality of tasks (210-228) that can be accomplished by at least one of the subsystem accessible for the workflows and groups the tasks into a plurality of roles (302-308) wherein each role includes at least one task to be performed. The roles are grouped into the workflows according to the roles needed to address an alarm condition. The workflow can be provided to an operator with a user interface (600).

### FIELD OF THE INVENTION

The present invention relates generally to creating workflows from data derived from a system and, in particular, a method and apparatus to creating and providing workflows that obtain tasks from a number of different systems and presenting those workflows according to roles of an operator.

### BACKGROUND

Networks or systems and in particular communication networks are made up of many different devices that can be located in disparate places and that can perform different functions within the network. As a system, these devices work together to provide the services of the network such as a wireless communication network. Regardless of the number of devices within the system, it is not possible to expect that every device will operate flawlessly or continuously. Disruptions, errors and faults occur and are to be expected.

Accordingly, network manufacturers and operators have designed, developed and operate various equipment and network management systems and subsystems that work with the network to detect, identify, characterize and resolve network disruptions, errors, and faults including fault management subsystems. Networks are also monitored by performance management subsystems, which provide data regarding the networks performance a given intervals, and configuration management subsystems, which monitor the current configuration of devices within a network. Collectively the fault management subsystem, performance management subsystem and configuration management subsystem are referred to as network management subsystems. Different network management subsystems are used to, among other things, monitor network conditions and detect alarm conditions of different types such that each subsystem is specialized. A network management system can consolidate the subsystems. Network management systems can use alarms and alarm conditions to notify a network developer or operator that there is a problem or issue with the system. These alarms can identify the disruption, error or fault and present them to the necessary individuals, and they can be used to assist an operator of a system or of one of the network management system to resolve the issues. As one of skill in the art can appreciate, however, that the alarm condition detected by one subsystem may not be resolved wholly by that subsystem and resources from other network management subsystems may be needed to resolve the alarm condition. Furthermore, there may be the need to access resources other than those available to the network management subsystems in order to resolve an alarm condition. In addition, the network management subsystems provide data regarding the operating conditions of the network such as data flowing through a base station and the like.

In addition, each of the network management subsystems may not be compatible with one another. They also may have different user interfaces that make operating them more difficult for operators of the system and subsystems. The different configurations of the network management subsystems leads to a long learning curve for the operators of the subsystems, inefficient usage of the subsystems as well as of the devices that are being monitored by the system.

Another issue presented by the current arrangement and usage of network management subsystems is that they do not facilitate an optimal amount of information sharing across the multiple subsystems as well as to the operators of those subsystems. The same alarm condition or network condition can be detected by different network management subsystems and presented to an operator in any number of different fashions. Thus, the reported alarm and network conditions can be redundant and the operations that an operator takes to resolve and analyze the conditions may be redundant because the process is across multiple platforms and network management subsystems.

In operation, current network management subsystems are loosely linked together to report alarm conditions to operators of the subsystems as they occur in the monitored system. Once an alarm condition is reported to the operator of the network management system, the operator is required to prioritize the alarm conditions according to their severity. While alarm conditions can be notified to the operator with severity levels, these severity levels are static and do not change over time so that an operator may begin resolving an issue that is not as critical as another issue.

Once an issue is selected to be analyzed or resolved, the operator relies on experience to go through the steps of addressing the issue. Many systems and subsystems may be needed to address the condition. This requires the operator to access each of the systems and subsystems individually to proceed through the necessary steps and tasks. After completing each step, the operator will have to exit the system or subsystem, go to another subsystem to perform other steps and then maybe return to the system or subsystem originally accessed. This process is repeated until the condition is resolved or completely analyzed and is repeated for each condition.

In view of the foregoing, there is a need for the various and divergent network management subsystems to be able to work together in a more effective and efficient manner. There is a need to be able to reduce the redundancy of the tasks performed by each of the network management subsystems during the resolution of a given alarm condition as well as reducing the alarm conditions from an operator's view. A mechanism that shares information across different network management subsystems would be beneficial. Furthermore, an organized user interface may improve the resolution of alarm conditions as well as increase the speed in which operators learn the systems that they operate. An effective user interface and configuration of the network management system is also needed to provide the information an operator uses to resolve alarm conditions.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a block diagram of a wireless communication system and network that utilizes some embodiments of the present invention.

FIG. 2 is an example of a network management system in accordance with the principles of the present invention.

FIG. 3 is a block diagram of the roles created to perform the tasks of the network management system of the present invention.

FIG. 4 is a block diagram of the workflows used to resolve alarm conditions in accordance with the principles of the present invention.

FIG. 5 is a block diagram of the workflows created in accordance with the principles of the present invention.

FIG. 6 is a block diagram of the user interface that displays the alarm conditions and connects to the workflows in accordance with the principles of the present invention.

FIG. 7 is a flow chart of the operation of forming and using the workflows of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to providing workflows that are used in connection with addressing network conditions and faults detected by network management systems. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a method and system of workflows that are used in connection with addressing network conditions detected by network management systems described herein. The non-processor circuits may include, but are not limited to, a radio receiver, a radio transmitter, signal drivers, clock circuits, power source circuits, and operator input devices. As such, these functions may be interpreted as steps of a method to utilize workflows used in connection with addressing network conditions detected by network management systems. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention provides a method of providing workflows to an operator of a network management system. The workflows are the process by which the operator proceeds through the different tasks and needed to address network condition that has been identified by a network management subsystem that operates within the network management system. The workflows are created by identifying a plurality of tasks that are completed in the process of resolving an alarm condition detected by the network management system. The tasks are individual steps that are completed by each of a plurality of network management subsystems. The tasks are then grouped into a plurality of workflows where each workflow includes at least one task. Workflows are logical grouping tasks that are to be performed together to accomplish a function, segment or part of the alarm condition. The workflows can comprise tasks from multiple network management subsystems. The workflows can be grouped together so that a network condition can be addressed or resolve according to the role of the operator. The present invention then displays the workflow so that the network management system and subsystems can proceed according to the roles and the tasks necessary to address or resolve the alarm condition.

In other words, workflows are the high level functions that need to be completed in order to address or resolve an alarm condition. The workflows may need to operate over a plurality of different network management subsystems. The workflows are made up of different processes or functions that each is performed as a part of the process used to resolve the alarm condition. Each workflow is made up of various different tasks, which can be thought of as the individual steps that must be completed to perform the workflow. Thus, when an alarm condition occurs, it is reported to the operator of the network management system. When the operator attempts to address the alarm condition, the operator is presented with a workflow of what is needed to be completed to analyze and then resolve the alarm condition and is customized according to the operator's role to be performed. The operator then proceeds through the workflow accessing each of the tasks that are to be performed. Within each of roles, the tasks that are necessary to complete the role are performed by the operator or by the subsystems. As the tasks are taken from across a plurality of different network management subsystems, the operator is able to access each of the subsystems in an organized manner without having to start and exit each subsystem individually.

A system of managing workflows needed to resolve alarm conditions found in a network is also presented. The system includes at least one subsystem that is used to monitor devices that are a part of the network. The subsystems detect alarm conditions that denote a fault, error or disruption within the system. Tasks are formed from the subsystems such that each task is an individual step performed by the subsystem as it functions to monitor and resolve alarm conditions. Workflows are formed by grouping tasks together that are performed to complete a function in the process of monitoring and resolving the alarm condition. Roles are formed by logically taking tasks and workflows that come from among the different subsystems within the network management system. Roles are created by grouping the workflows necessary to address or resolve an alarm condition. The workflows are presented to the operator of the system and subsystems according to the operator's chosen role using a customized user-interface that displays the workflow and provides access to the different subsystems. Thus, the operator seamlessly accesses the different subsystems to complete the tasks as a part of a role needed to be performed to resolve the alarm condition.

The present invention includes a common component architecture for a user interface that is used to address network conditions and resolve alarm conditions within a network, including wired and wireless communication networks. The architecture includes a library of tasks that are performed by various subsystems used to monitor and resolve alarm conditions within the network. Workflows are formed from the tasks by grouping the tasks into logical steps that are completed during the process of resolving an alarm condition. Roles are formed from the workflows that are necessary to address the identified issue or alarm condition according to the function of the operator of the network management system. The workflows provide access across the different subsystems needed to address or resolve issue or condition. The workflow is presented to the operator of the architecture by way of a user interface that permits the operator to access the different subsystems used to analyze and resolve the issues and complete the tasks.

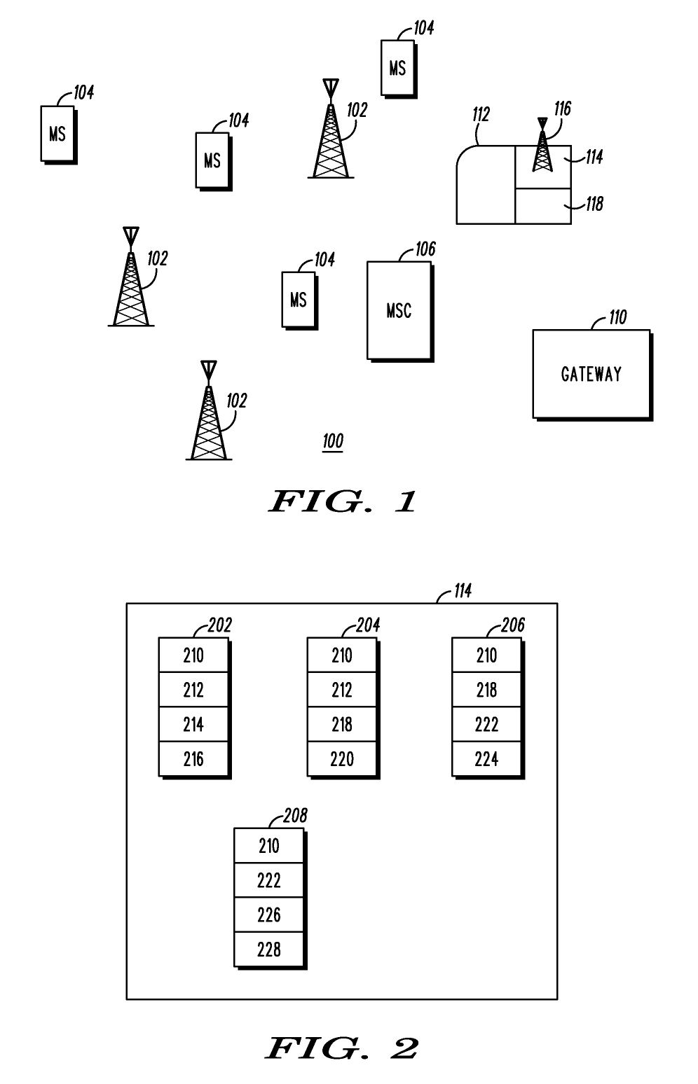

Referring to FIG. 1, block diagram of a system 100 that uses the dynamic network management system of the present invention is shown. While the present invention applies to any system that has multiple devices that operate with one another to create a system, the present invention is described in the context of a wireless communication system such as a code division multiple access (CDMA), global system of mobile communication system (GSM) or universal mobile telecommunication system (UMTS) cellular communication systems. The system 100 includes a plurality of base stations 102 that communicate over wireless channels with multiple mobile stations 104. The system may also include a plurality of network devices that operate with base stations 102 to effectuate the mobile communications. These network devices include mobile switching centers 106 that are coupled to the base stations to control the communications between the base stations 102 and mobile stations 104. In addition, gateways 110 may be provided that link the system 100 with other communication systems that are controlled by different network devices.

The system also includes devices 112 to monitor the performance of the overall system. Devices 112 may include a network management system 114 of the present invention. The network management system 114 may include a receiver 116 that receives data regarding the performance of the devices within the network including alarm conditions that are detected by the devices or by components of the network management system 114. In addition, the network management system includes a processor 118 that is coupled to the receiver 116 to process the alarm conditions received by the system.

FIG. 2 provides a block diagram of the network management system 114 of the present invention and the components that provide the functionality to dynamically monitor alarm conditions in the system 100. The network management system can include a number of different network management subsystems including, but not limited to, a fault management subsystem 202, a performance management subsystem 204, a configuration management subsystem 206 and a problem management subsystem 208. These subsystems are used by network engineers, planners, managers and technicians that monitor the system 100, detect, address and resolve alarm conditions.

Each of the different subsystems is made up of known components that monitor the system 100 and the devices within the system for the specific purposes of the subsystem, such as fault management, configuration management. The operation of each of these subsystems is generally known by those of ordinary skill in the art. To perform its function of monitoring, addressing and resolving alarm condition within the system, each subsystem performs a number of tasks or steps. For example, one management subsystem may monitor the operation of the base station 102. One of the functions therefore may be to determine the flow of data through each base station 102. In order to do so, the management subsystem can be divided up into different tasks that are performed by the subsystem. Accordingly, fault management subsystem 202 may include tasks 210, 212, 214 and 216, performance management subsystem 204 may include tasks 210, 212, 218 and 220, configuration management subsystem 206 may include tasks 210, 218, 222 and 224 and a problem management subsystem 208 may include tasks 210, 222, 226 and 228. As can be seen, there are certain tasks, e.g. task 210, that is performed by each of the management subsystems. Other tasks, e.g. tasks 212, 218 and 222, that a performed by more than one of the management subsystems. Each subsystem also includes tasks, e.g. tasks 216, 220, that are particular to that subsystem.

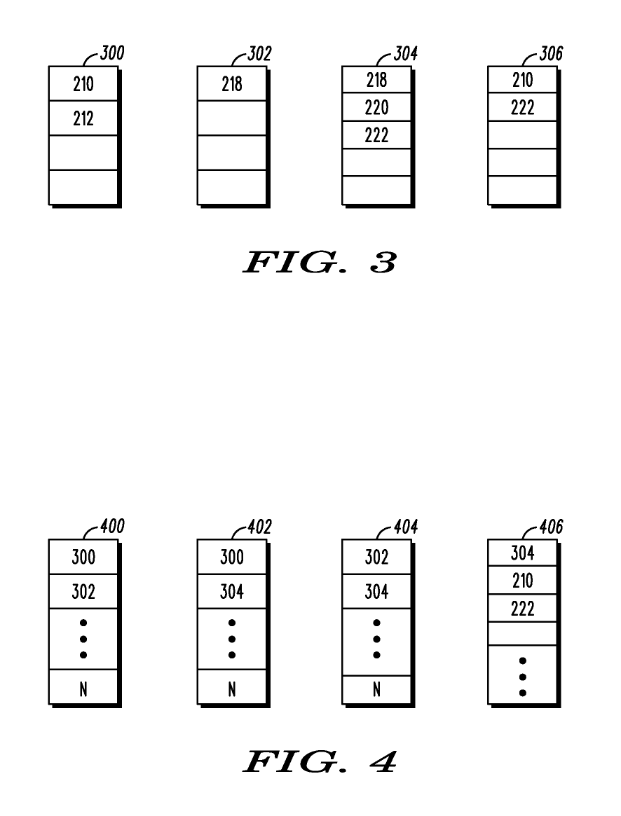

FIG. 3 is a block diagram of the workflows configured as a part of the present invention. Workflows are functions that are performed by the network management systems 202-208 in the process of monitoring, detecting, addressing and resolving alarm conditions that occur in the system 100. As tasks are the individual steps or operations that are performed by each of the subsystems, workflows are a grouping of tasks that are to be performed to complete a routine or function within the various network management subsystems 202-208 or among network management subsystems. As seen in the figure, a workflow includes at least one task identified and can include any number of tasks. In addition, the workflow can include tasks that come from different subsystems. Furthermore, workflows can use tasks that are also used by other workflows. For example, workflow 300 is a logical arrangement of tasks 210, 212 that are needed to complete the function identified as the workflow. In addition, workflow 302 can be completed by doing task 218, while workflow 304 requires tasks 218, 220 and 222. Workflow 306 is another example where tasks 210 and 222 have been identified as necessary to complete the function.

Accordingly, workflows are logical groupings of tasks that effectively perform a function. As the workflows can include tasks from different subsystems, the components and tasks of a workflow are not limited to those tasks performed by the individual subsystem that identified an alarm condition or that is selected to address or resolve the alarm condition. Workflows can therefore be created to access multiple different subsystems that otherwise would require an operator to exit a subsystem and access a different subsystem. This provides a seamless connection between the different subsystems and provides an effective and efficient to address or resolve alarm conditions with minimal intervention by an operator.

Turning to FIG. 4, roles 400, 402, 404 and 406 are shown. Roles correspond to the function that an operator or operator of a network management subsystem 202-208 will take in response to a network condition or an alarm condition. An operator of the subsystem can perform different roles at different times. For example, an operator of a performance management subsystem may be gather data regarding performance of a given cell or for devices over a given period of time. Each role requires the operator to perform different tasks and workflows. An operator can have a primary role that interacts with the different subsystems an occasionally need to access different roles. Alternatively, an operator can switch between many different roles.

As alarm conditions and network conditions are identified, the network management system 114 or subsystems 202-208 determines appropriate workflows to resolve the alarm condition. Alternatively, the system or subsystems will select to address the network or alarm condition in a manner other than completing a resolution. For example, it may be appropriate for an alarm condition to be monitored for a period of time, to be put on hold for a period of time or until a threshold number of similar alarm conditions have been reached, or to close the alarm condition without a specific resolution. The steps that an operator needs to take in order to address the alarm condition or to reach a resolution is known as the workflow. While one of the network management subsystems 202-208 may identify the alarm condition, the resolution may require access to other network management systems 202-208 as well as other resources within or without of the system 100. As the workflows 303-306 are created from tasks 210-228, which in turn are taken from the operations of the various network management subsystems, the roles 400-406 are formed from the different workflows that are necessary to address the various alarm conditions. For example, role 400 is identified by an operator of network management system 114 and then the appropriate workflow is given to address the given issue. Role 400 has been identified as including workflows 300 and 302, which in turn include identified tasks, such that role 400 includes tasks 210, 212 and 218. Role 402 uses workflows 300 and 304, which incorporate tasks 210, 22, 218, 220 and 222 to address the identified alarm condition. Similarly, role 404 encompasses workflows 302 and 304 which refer to tasks 218, 220 and 222.

While roles include various workflows, some roles refer directly to tasks that have not been assigned to roles. Role 406 utilizes workflow 304 as well as tasks 210 and 222 as the necessary steps to complete the workflow chosen by the operator. As such, it can be seen that tasks do not need to be identified as a part of a role and that a work flow can refer to a task, as the case may require.

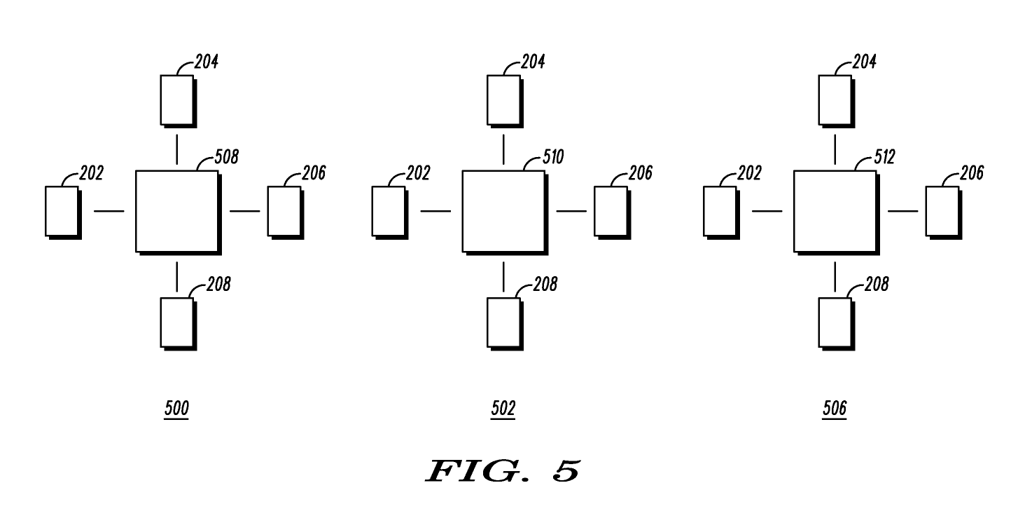

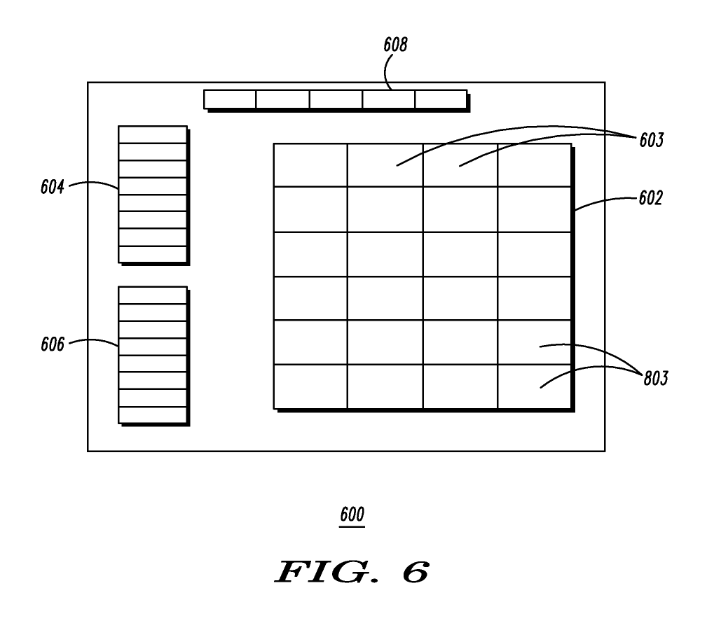

FIG. 5 also illustrates the workflows of the present invention. Workflow 500 is identified as a method to address or resolve a given alarm condition that may arise in system 100. Workflow 500 is coupled to various network management subsystems 202-208 that can be accessed through an interface 508. Similarly, workflows 502 and 504 are coupled to network management subsystems 202-208 and each have an interface 510 and 512 respectively. Interfaces 508-512 can present or display to the operator of the network management system 114 and the network management subsystems 202-208 the alarm conditions and workflows that have been determined to address the alarm conditions. Accordingly, the interfaces will present data to the operator and prompt the operator for inputs etc. as the alarm condition is addressed. As the interfaces 500-504 are coupled to each of the network management subsystems 202-208, the workflows have access to each of the subsystems. As the workflows proceed through the tasks according to the roles, the workflow has access to each of the tasks 210-228 regardless of in which subsystem 202-208 the task is performed and can seamlessly flow between the subsystems without the intervention of the operator. Thus, the present invention has ready access to each of the tasks that are required to address an alarm condition.

FIG. 6 is a block diagram that illustrates an embodiment of a user interface of the present invention. As understood from the description above, the user interface 508 is linked to the various subsystems 202-208 that monitor the system 100. When a network or alarm condition is identified, it can be displayed in the reporting section 602 of the user interface 508. It has been determined the required workflow that will be conducted to address the condition. Reporting section 602 can be configured in different formats depending on the role and preferences of the operator. In one example, the alarms are displayed in chronological order in which the alarm conditions are received. It is also possible to rate the alarm conditions according to a level of severity or whether the alarm condition is non-actionable, actionable or may be an incident that will affect service within the system 100. Accordingly, the reporting section 602 can be arranged where network and alarm conditions have a similar rating or classification can be displayed together. The reporting section 602 can be arranged such that it displays a reference to each alarm condition that has been reported. Hover menus can be used such that when an operator refers to a specific alarm condition the details of the alarm condition are quickly and easily displayed.

The reporting section 602 may be arranged in the form of a matrix 606 that displays visual cues to represent the status of a particular metric being reviewed by the system and subsystems. The matrix can include multiple cells 603 that represent different devices within the system 100 and cells can be sorted according to different attributes that are monitored. The cells can be configured to represent different conditions in the system 100. The matrix can visually represent alarm conditions that impact the system for specific device classes as well as other groupings of devices and services. The cells can be color coded according to the class of alarm condition. Such color coding can take historical data regarding the device and alarm conditions into consideration. The cells within the matrix can be selectable and provide relevant information related to the alarm condition and linking to a detailed report summarizing the alarm condition. Sorting options for the matrix allow the operator to configure the matrix according to the various uses of the network management system.

User interfaces 508-512 can also include a ranking section 604. As stated, reported alarm conditions can have different levels of severity and can affect the system 100 in a variety of ways. Thus, there are various methods of being able to rate an alarm condition and then rank the rated alarm conditions against one another as described in co-pending United Patent Application entitled Method and Apparatus to Dynamically Prioritize Network Faults Based on Real-Time Service Degradation which is jointly owned by the assignee of this application and filed concurrently herewith. The ranking section 604 can be dynamic such that as conditions vary within the system 100, and the ranking of an alarm condition can also vary. For example, an alarm condition that has been identified for a base station 102 indicates a fault for the base station can have a relatively low severity level when the alarm was first reported because the traffic on the base station was also relatively low, which does not warrant the alarm condition appearing in section 604. As data flowing through the base station increases, the severity level of the alarm condition can increase such that the alarm condition needs to be resolved or other devices within the system. Thus, the alarm condition may need to appear on the section 604. As the utilization of base station 102 improves or the alarm condition is resolved, the alarm condition can be removed for section 604.

An incident list 606 can also be included. The incident list 606 is a condensed list describing the context information of the various alarm conditions that are displayed in reporting section 602 and ranking section 604. The attributes of the incident list can include multiple views of the relevant alarm conditions, a scrollable list of the applicable incidents. In addition, context information related to the incident can be acquired.

The user interface 508 can produce and display incident reports. Incident reports can be arranged as a series of charts, tables, lists, and other components that describe a given alarm condition. The report is a visual representation of the related metrics for the alarm condition. It can include a table of recent event activity related to the device reporting the alarm condition and of related devices. Tables of other related alarm conditions can be included.

In view of the foregoing, the user interface 508 can provide an operator of the network management system 114 and subsystems 202-208 according to the roles of the operator with the information necessary to understand an alarm condition and how to resolve the alarm condition. An operator can perform different roles 402-408 within the scope of operating a network management subsystem 202-208. Each role requires different workflows 202-208 and tasks 210-228. Accordingly, the user interface 600 can be configured differently for each role that an operator is performing. For example, as a base station technician, the user interface 600 can be configure to present network conditions for the base stations within the system or to present alarm conditions for the base stations within a cell. In order to switch between different roles, a tab interface 608 can be a part of the user interface 600. Accordingly, the operator selects the role that is be performed from the tab interface 608 and the corresponding format of the user interface including the format and information in the reporting section, ranking section and incident section are presented.

As the user interface is coupled to each of the network management subsystems, the user interface can be arranged according to different criteria including different alarm conditions, network management subsystems, devices within the system 100 and operator preferences. The user interface can be specifically configured for a particular operator of one of the network management subsystems 202-208. The reporting section 602 will display all the alarm conditions that are relevant to the particular operator. The ranking section 604 will distill the alarm conditions according to severity level. The operator can obtain information regarding any alarm condition by accessing the alarm condition. The operator can also obtain the workflows necessary to address and resolve the workflows through the user interface. When the alarm condition is accessed, the operator is presented with the workflow and the operator can proceed to access the tasks that are associated with the workflow.

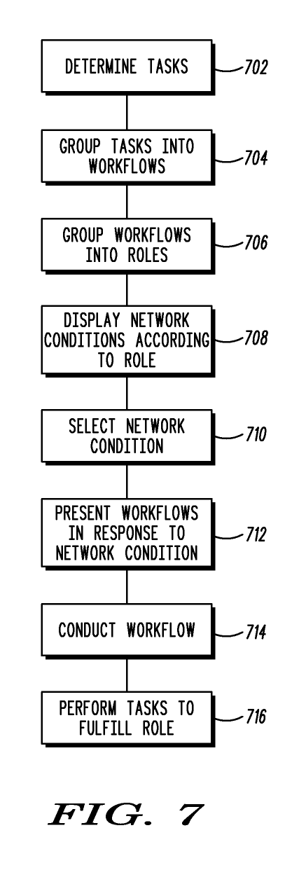

Turning to FIG. 7, a flow chart 700 illustrating the method of developing and using the workflows of the present invention is shown. As mentioned, the workflows are developed from the network management subsystems 202-208 that comprise the network management system 114 of the present invention. The method begins by examining the network management subsystems 202-208 and determining 702 the various tasks 210-228 that are included in each of the network management subsystems. These tasks 210-228 are the individual steps or small groupings of steps that each network management subsystem 202-208 performs in the course of its operations. These steps may include sending paging messages to devices within the system 100, storing data into data repositories and the like. The tasks 210-228 are then grouped 704 into workflows 302-308 that would be conducted according to the role of the operator. As defined, workflows 302-308 are functions that are performed in course of a workflow. In addition, workflows 302-308 can include tasks from various different network management subsystems 202-208. Workflows are formed by reviewing the tasks that an operator of the network management system 114 and network management subsystems 202-208 perform. For example, a workflow can be to access information regarding the status of a base station 102. This would include sending a paging signal to the base station, receiving a response from the base station, sending a request for stored information to a data repository and receiving the stored information from the data repository. In addition, the communications with the base station may be performed by one of the network management subsystems while the communications with the data repository may be performed by another of the network management subsystems. Each of the network management subsystems accessed by the workflow also may include tasks that are performed by both subsystems. Thus, it is seen that the workflows 302-308 can comprise tasks from different network management subsystems 202-208 and can choose between tasks performed by the accessed network management subsystems depending on the criteria of the workflows. Workflow 302 may access task 210 from subsystem 202 while task 210 will be accessed from a subsystem 204 by workflow 304 because the workflow 302 relies on subsystem 202 more than workflow 304.

Roles are formed by grouping 706 the workflows into the processes that are performed by operators and operators of the network management system 114 and subsystems 202-208 in addressing or resolving alarm conditions. Each operator can have different roles, which are selected by the tabs on the user interface. In addition, operators of different subsystems can perform the same roles 400-406 and workflows 300-306. In other words, an alarm condition is examined to determine the different workflows that need to be performed in order to address or resolve that alarm condition. For example, if a base station is reporting high incidents of dropped calls, the network management subsystem may need to obtain information about the current status of the base station, the historical patterns of the base station, data regarding adjacent base stations and other devices within the system 100. The role of the operator may be to analyze the data such that one network management subsystem attempts to determine if there is an error in the operation of the base station while another network management subsystem attempts to determine that during given times of the day there is too much data traffic flowing through the base station for optimal operation. For each of the alarm conditions that are to be monitored and handled by the network management system 114, different workflows are determined and created.

As stated, the user interface 600 includes a reporting section 602 and a ranking section 604. The user interface can display 708 data according to different criteria inherent to the role of operator using the system and the interface. In one embodiment, the user interface 600 displays all alarm conditions that are being reported. In this embodiment, the reporting section 602 can be arranged in a format that displays the most recent alarms first while the ranking section is used to display the ranking of all alarm conditions regardless of when such alarm conditions are reported. In another embodiment, user interface can be arranged to display alarm conditions that are monitored by one of the network management subsystems. In yet another embodiment, the user interface can display the alarm conditions according to the operator of the system 114. In this embodiment, the user interface displays those alarm conditions that are to be addressed by the operator while other alarm conditions are not displayed. Thus, the operator will only see alarm conditions of direct concern. Other arrangements can also be used. In addition, each different user interface can use the reporting section 602 and ranking section 604 in different ways depending on the needs of the operator.

The operator of the network management system 114 and subsystems 202-208 sees the chosen format of the display 708 and therefore the relevant alarm conditions. From the display, an alarm condition can be selected 710. The operator can choose alarm conditions based on different criteria, e.g. needing information, attempting to resolve the alarm condition, etc. In one embodiment, the operator selects 710 an alarm condition for resolution. Thus, a workflow is provided 712 to the operator to follow. The workflow begins 714 the workflow and proceeds to perform 716 the various tasks that are required by accessing the tasks. Some workflows and tasks may require interaction with the operator, while other workflows can be performed independently by the subsystems 202-208. During the course of working on one workflow, the operator may select other alarm conditions and begin other workflows depending upon the needs and capabilities of the system 114, the operator and the network management system 114 and subsystems 202-208.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of providing workflows comprising:
identifying a plurality of tasks that can be accomplished by at least one system accessible for the workflows;
grouping the tasks into a plurality of workflow wherein each role includes at least one task to be performed;
grouping the workflows into at least one role according to preferences of an operator the, and
providing the workflows for use by an operator.

2. The method of claim 1 wherein the tasks are derived from at least one system.

3. The method of claim 1 wherein the at least one system is one of among a fault management system, a performance management system, a configuration management system and a problem management system for a communication network.

4. The method of claim 1 further comprising accessing a system that performs the tasks.

5. The method of claim 1 further comprising operating a system that performs the tasks to complete the workflows.

6. The method of claim 1 further comprising displaying a user interface to the operator wherein the user interface presents the workflows to the operator and accesses the tasks to complete the workflows.

7. The method of claim 1 wherein providing the workflows comprises ranking the workflows according to a hierarchy.

8. A system of managing workflows comprising:
at least one subsystem used to manage at least a part of the workflow;
tasks formed from the at least one subsystem wherein each task is an element of the subsystem and at least a part of the workflow;
roles comprising at least one task needed to complete at least a part of the workflow;
customized user-interface derived by the workflows needed to complete a role wherein the user interface provides access to the tasks across the at least one subsystem to complete the workflow.

9. The system of claim 8 wherein the subsystems are one of among a fault management system, a performance management system, a configuration management system and a problem resolution system.

10. The system of claim 8 wherein the user-interface displays the workflow and accesses the tasks needed to complete the workflow.

11. The system of claim 8 wherein the at least one subsystem is operating in parallel with at least one subsystem.

12. The system of claim 8 wherein the user interface is customized for different operators of the system according to the workflow.

13. The system of claim 8 further comprising multiple paths to reflect a flat option hierarchy of the workflows.

14. A common component architecture for a user interface comprising:
a library of tasks performed by at least one system;
workflows formed from at least one of the tasks wherein the workflows are to be completed as at least one step in addressing an identified issue in a network;
roles of workflows necessary to address the identified issue and wherein the roles provide access across the at least one system to resolve the identified issue, and
an interface to present the workflows to an operator of the architecture to resolve the identified issue.

15. The architecture of claim 14 wherein the at least one system is one of a fault management system, a performance management system, a configuration management system and a problem resolution system.

16. The architecture of claim 14 wherein the interface is configurable according to the identified network conditions.

17. The architecture of claim 14 wherein the task is an activity performed by an operator to resolve the identified network condition.

18. The architecture of claim 14 wherein a role is a logical grouping of tasks based on common functions used to resolve the identified issue.
